(19) United States
(12) Patent Application Publication
(10) Pub. No.: US 2014/0294380 A1
(43) Pub. Date: Oct. 2, 2014

(54) OPTICAL DEVICE AND TRANSMITTER

(71) Applicant: Fujitsu Optical Components Limited, Kawasaki-shi (JP)

(72) Inventors: Masaki Sugiyama, Sagamihara (JP); Shinji Maruyama, Sapporo (JP)

(73) Assignee: Fujitsu Optical Components Limited, Kawasaki-shi (JP)

(21) Appl. No.: 14/193,677

(22) Filed: Feb. 28, 2014

(30) Foreign Application Priority Data
Mar. 28, 2013 (JP) 2013-070662

(51) Int. Cl. G02B 6/14; H04B 10/079

(52) U.S. Cl. CPC G02B 6/14; H04B 10/0799
USPC 398/28; 385/14

(57) ABSTRACT

An optical device includes an optical waveguide that includes an incident waveguide, parallel waveguides along an electrode, and emission waveguides, formed on a substrate having an electro-optical effect, a first emission waveguide among the emission waveguides is set as an output waveguide of signal light, for output to an external destination and a second emission waveguide among the emission waveguides is set as a monitoring optical waveguide for the signal light; a photodetector that is disposed over the monitoring optical waveguide; and a groove formed on a portion of the substrate, where the photodetector of the monitoring optical waveguide is disposed. The monitoring optical waveguide has a width that, as compared with the width at a starting point side, is formed to increase as the monitoring optical waveguide approaches the groove.

### CROSS REFERENCE TO RELATED APPLICATIONS

This application is based upon and claims the benefit of priority of the prior Japanese Patent Application No. 2013-070662, filed on Mar. 28, 2013, the entire contents of which are incorporated herein by reference.

### FIELD

The embodiments discussed herein are related to an optical device and a transmitter that are used in optical communication.

### BACKGROUND

With respect to optical devices, for example, one optical waveguide device uses an electro-optical crystal substrate such as an LiNbO3 (LN) substrate and an LiTaO2 substrate. This optical waveguide device is made by forming a metal film of titanium (Ti), etc., on a part of the surface of the substrate and thermally diffusing the film to form an optical waveguide. Alternately, the optical waveguide is formed by proton exchange in benzoic acid after patterning. Thereafter, by disposing electrodes in a vicinity of the optical waveguide, an optical modulator and optical switch can be configured.

The optical waveguide of the optical modulator includes an incident waveguide, parallel waveguides, and an emission waveguide; and a signal electrode and a ground electrode are disposed over the parallel waveguides to form coplanar electrodes. An LN modulator uses a X-cut LN substrate or a Z-cut LN substrate. If a Z-cut LN substrate is used, a change of index of refraction by the electric field in the Z direction is utilized. To enhance the effect of application of the electric field, electrodes are arranged right over the waveguides. Although the signal electrode and the ground electrode are patterned over the parallel waveguides, to prevent the light propagated in the parallel waveguides from being absorbed by the signal electrode and the ground electrode, a buffer layer is disposed between the LN substrate and the signal electrode/ground electrode. SiO2, etc. of a thickness on the order of 0.2 to 2 micrometers is used for the buffer layer.

In the case of driving such an optical modulator at high speed, ends of the signal electrode and the ground electrode are connected by a resistor to serve as a traveling-wave electrode and a microwave signal is applied from the input side. At this moment, by the electric field, the index of refraction of one pair of parallel waveguides A and B changes to +Δside and −Δside, respectively and a phase difference between the parallel waveguides A and B changes. This causes signal light that has been intensity-modulated by the Mach-Zehnder interference to be output from the emission waveguide. High-speed optical response characteristics can be obtained by controlling the effective refractive index of the microwave by the change of a cross-sectional shape of the electrode so that the speeds of the light and the microwave will be caused to match.

In the Mach-Zehnder modulator such as the LN modulator, the voltage at which the light is off (operation point voltage) changes consequent to temperature changes. Therefore, the operation point voltage is adjusted by receiving and monitoring a part of the light output and by imparting a bias voltage from an external device according to the amount of light received. In the Mach-Zehnder modulator, among two outputs, one is output as the signal light and the other (off light) is used as monitoring light. Since two outputs are complementary signals and the output power of the monitoring light is equivalent to the output power of the signal light, the received optical power of the monitoring light can be made large and the bias control can be performed steadily.

When a photodetector (PD) to receive the monitoring light is disposed outside the substrate, a space is required for mounting the PD and the overall size (package size) becomes large. For this reason, a technique of mounting the PD over the emission waveguide of the substrate to thereby make the package smaller has been developed (see, e.g., Japanese Laid-Open Patent Publication No. 2001-215371).

Further, a technology has been developed of mounting the PD over the emission waveguide and disposing a groove and a mirror on the substrate under the PD to reflect the light (see, e.g., Japanese Laid-Open Patent Publication Nos. 2007-240781, 2005-250178, and 20003-294964). The amount of light to be received by the PD can be increased by disposing the groove directly beneath the PD and causing the light to be reflected by the bottom surface and the side surface of the groove.

In the configuration of mounting the PD over the emission waveguide of the substrate, however, the received optical power of the PD is small. In this configuration, part of the light propagated in the waveguide, namely, the evanescent wave that leaks to the PF side, is received by the PD. For this reason, the received optical power cannot be made large.

In the configuration of disposing the groove directly beneath the PD, since the received optical power decreases when the grooves become shallow, there is a problem that manufacturing variation becomes large depending on the depth of the groove. While the mode field of the light is on the order of 6 to 10 micrometers in the depth direction of the groove, there arises a manufacturing process problem if the depth of the groove is deepened so as to cover the mode field as a whole. In the case of disposing the groove on the substrate, the etching process is used. As the depth of the groove becomes deeper, etching time becomes longer and manufacturing throughput is lowered. Further, the risk of cracking, etc. of the substrate increases, leading to decreases in yield.

### SUMMARY

According to an aspect of an embodiment, an optical device includes an optical waveguide that includes an incident waveguide, parallel waveguides along an electrode, and emission waveguides, formed on a substrate having an electro-optical effect, a first emission waveguide among the emission waveguides is set as an output waveguide of signal light, for output to an external destination and a second emission waveguide among the emission waveguides is set as a monitoring optical waveguide for the signal light; a photodetector that is disposed over the monitoring optical waveguide; and a groove formed on a portion of the substrate, where the photodetector of the monitoring optical waveguide is disposed. The monitoring optical waveguide has a width that, as compared with the width at a starting point side, is formed to increase as the monitoring optical waveguide approaches the groove.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a plane view of an optical device according to a first embodiment;

FIG. 2 is a side cross-sectional view of a groove formed on the optical device according to the first embodiment;

FIG. 3 is a plane view of the optical device according to a second embodiment;

FIGS. 4A and 4B are graphs of received optical power and extinction ratio;

FIG. 5 is a plane view of the optical device according to a third embodiment;

FIG. 6 is a plane view of the optical device according to a fourth embodiment;

FIGS. 7 and 8 are plane views of the optical device according to a fifth embodiment;

FIG. 9 is a plane view of the optical device according to a sixth embodiment; and

FIG. 10 is a block diagram of a transmitter having the optical device according to a seventh embodiment.

### DESCRIPTION OF EMBODIMENTS

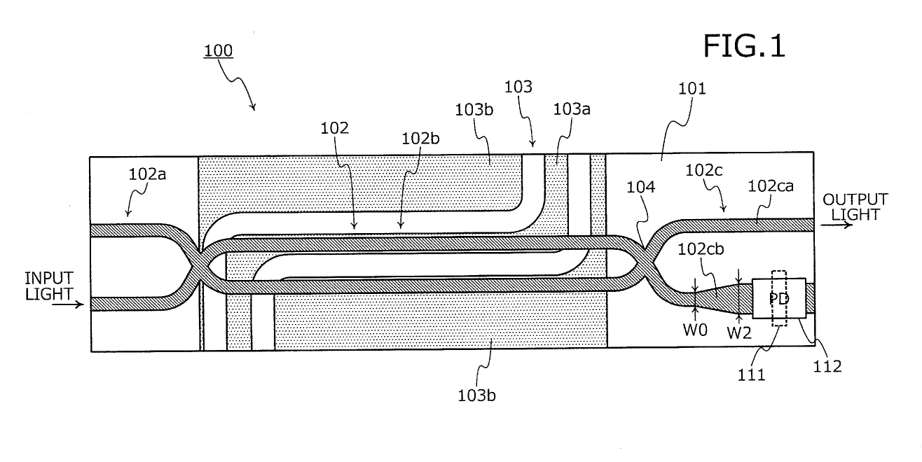

Embodiments of an optical device and a transmitter will be described in detail with reference to the accompanying drawings. FIG. 1 is a plane view of an optical device according to a first embodiment.

An optical device 100 depicted in FIG. 1 represents a configuration example of a Mach-Zehnder-type optical modulator having an optical waveguide 102 and an electrode 103 disposed on a substrate 101 such as an LN substrate, etc., that has an electro-optical effect. The optical waveguide 102 includes an incident waveguide 102a, a pair of parallel waveguides A and B (102b), and an emission waveguide 102c. Incoming light enters one of the incident waveguides 102a. Over the parallel waveguides 102b, a signal electrode 103a of the electrode 103 is disposed along the parallel waveguides 102b and, on both sides of the signal electrode 103a, a ground electrode 103b is disposed to form a coplanar electrode.

A coupler (2×2 coupler) 104 is disposed at the output side of the parallel waveguides 102b and this coupler optically couples the parallel waveguides 102b to two emission waveguides 102c. From one emission waveguide 102ca among the two emission waveguides 102c, the light is output to an external destination as an output light. The other emission waveguide is used as a monitoring optical waveguide 102cb.

The light output from the emission waveguide 102ca at the end of the substrate 101 is spatially propagated by way of optical elements of a lens, etc. (not depicted) and is linked to an output fiber.

A groove 111 is disposed on the substrate 101 of the monitoring optical waveguide 102cb and a photodetector (PD) 112 is disposed over the groove 111. This groove 111 is formed at a right angle to the monitoring optical waveguide 102cb (traveling direction of light).

The width of the monitoring optical waveguide 102cb is W0 at an output part of the coupler 104 and is W2 at a part reaching the groove 111. With the width set as W0<W2, the monitoring optical waveguide 102cb is formed to have a gradually increasing width as the monitoring optical waveguide 102cb approaches the groove 111.

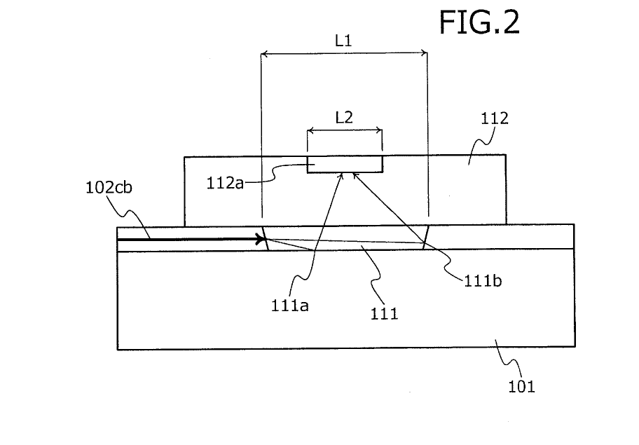

FIG. 2 is a side cross-sectional view of the groove formed on the optical device according to the first embodiment. The width of this groove 111, namely, width L1 in the traveling direction of the light, is caused to correspond to the area (width of L2) of a light receiving surface 112a of the PD 112. In this case, since the optical power received at the PD 112 changes according to the reflecting state of a reflecting surface (e.g., bottom surface 111a and side surface 111b) of the groove 111, width L1 of the groove 111 is determined taking into account the reflecting state of the groove 111.

If the side surface 111b of the groove 111 is inclined beyond a right angle toward the obtuse side to have a predetermined angle at which the light is reflected toward the PD 112 side, the amount of reflected light in the direction of the PD 112 can be increased. Further, the light reflection rate can be enhanced by forming a metal film, etc. of a high reflection rate by vapor deposition, etc., on the reflection surfaces (bottom surface 111a and side surface 111b).

The groove 111 has to be a groove of 6 micrometers or less in depth as a condition for not causing the manufacturing process problem described above. For this reason, as depicted in FIG. 1, the width W2 of the groove 111 part of the monitoring optical waveguide 102cb is made larger than the waveguide width W0 at the output part of the coupler 104 (starting point side of monitoring optical waveguide 102cb). An effective refractive index difference can be made large by making the width of the monitoring optical waveguide 102cb large. This strengthens the light confinement in the depth direction of the substrate 101 and concentrates the optical power in the vicinity of the surface of the substrate 101 and a sufficient amount of light can be reflected by the groove 111 even if the groove is made shallow.

Thus, in the first embodiment, while the depth of the groove 111 can be made shallow, the index of refraction inside the groove 111 becomes important. Over the groove 111, the PD 112 is mounted and the PD 112 is bonded to the substrate 101 by an adhesive. The index of refraction inside the groove 111 differs between a case where the adhesive is inside the groove 111 and a case where air is inside the groove 111. For this reason, the light path differs and the optical power received at the PD 112 differs, according to the amount of the adhesive inside the groove 111.

To obtain a stable amount of light received at the PD 112, the inside of the groove 111 formed in the monitoring optical waveguide 102cb is filled up with the adhesive. The position of the PD 112 is only required to be determined so that the amount of light received will be maximized. When the groove 111 is so small that it is difficult to fill up the inside of the groove 111 with the adhesive, a stable amount of light can be received by attaching the PD 112 to the surface of the substrate 101 by the bonding and making the inside of the groove 111 an open space (air layer).

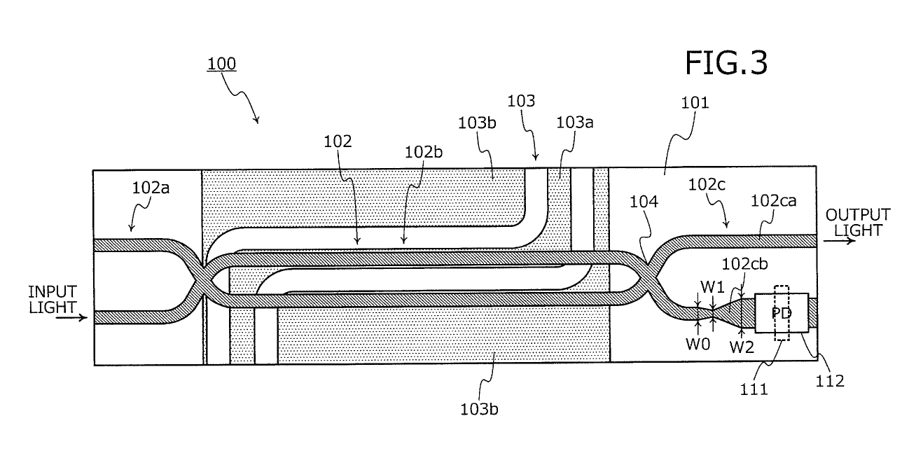

FIG. 3 is a plane view of the optical device according to a second embodiment. The second embodiment describes a configuration example of suppressing deterioration of the extinction rate. In FIG. 3, components identical to those depicted the first embodiment (FIG. 1) a given the same reference numerals used in the first embodiment.

The light propagated in one monitoring optical waveguide 102cb is changed to multi-mode light by a width-extended waveguide shape and is radiated and diffused from the end of the substrate 101. This light, when mixed with the output light output from the emission waveguide 102ca and spatially propagating, deteriorates the extinction ratio of this output light.

In the second embodiment, to suppress the deterioration of the extinction ratio, the width of the waveguide is partially formed narrowly in the course from the Mach-Zehnder output part (coupler 104) to the PD 112. In the example depicted in FIG. 3, the width of the monitoring optical waveguide 102cb is determined so that a relationship of W1<W0<W2 is satisfied, where the width of the output part of the coupler 104 is given as W0, the width of the groove 111 part of the waveguide is given as W2, and the width between the coupler 104 and the groove 111 is given as W1. With width W0 at a starting point side as a reference and in the traveling direction of the light, the monitoring optical waveguide 102cb is formed to narrow to width W1 and thereafter, widen up to width W2 at the groove 111 portion. Width W1 is less than or equal to a width that allows passage of only the single-mode light.

Of the monitoring optical waveguide 102cb, a portion where the width narrows to width W1 becomes a single-mode waveguide. This portion radiates and removes high-order-mode light as noise, from the light propagating in the waveguide, thereby enabling the deterioration of the extinction ratio of the light output from the emission waveguide 102ca to be suppressed.

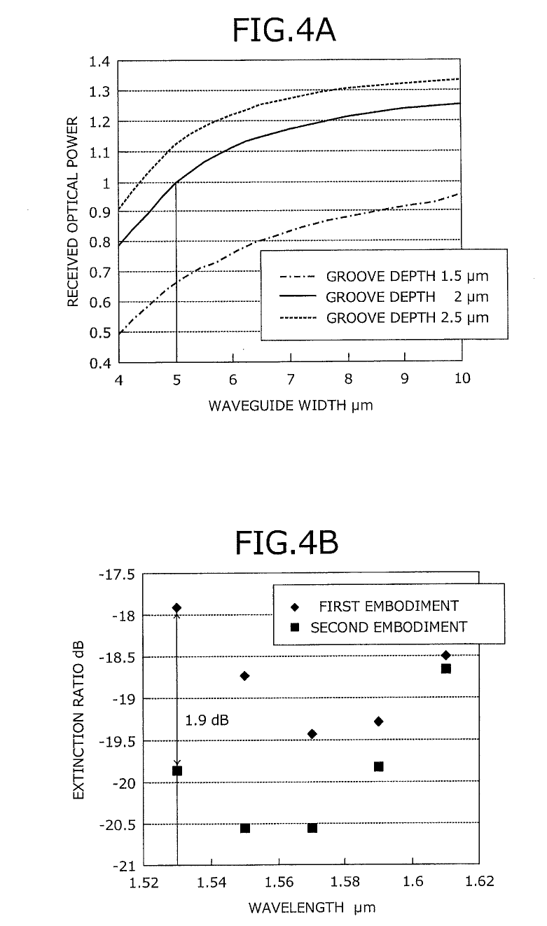

FIGS. 4A and 4B are graphs of the received optical power and the extinction ratio. FIG. 4A denotes the received optical power in the first and the second embodiments. The horizontal axis represents the width of the monitoring optical waveguide 102cb and the vertical axis represents the received optical power. The received optical power is depicted for a case where the power is given as 1 and is received by the PD 112 when the groove depth is 2 micrometers and width W0 is 5 micrometers. The received optical power can be increased by 10 percent by increasing width W2 to 6 micrometers and by 20 percent by increasing width W2 to 7.6 micrometers.

Thus, the tendency to be capable of increasing the received optical power by widening the waveguide width is true even if the groove depth is changed within a range of 1.5 to 2.5 micrometers. Therefore, designing width W2 of the monitoring optical waveguide 102cb to be wide enables a necessary amount of light to be received even if the depth of the groove 111 becomes shallow due to manufacturing errors, etc.

FIG. 4B denotes the extinction ratio in the first embodiment (FIG. 1) and the second embodiment (FIG. 3). The horizontal axis represents wavelength and the vertical axis represents the extinction ratio. As described in the second embodiment (FIG. 3), the extinction ratio can be reduced by preparing in the monitoring optical waveguide 102cb, a portion having the reduced width W1. For example, the extinction ratio can be reduced by 1.9 dB at the wavelength of 1.53 micrometers.

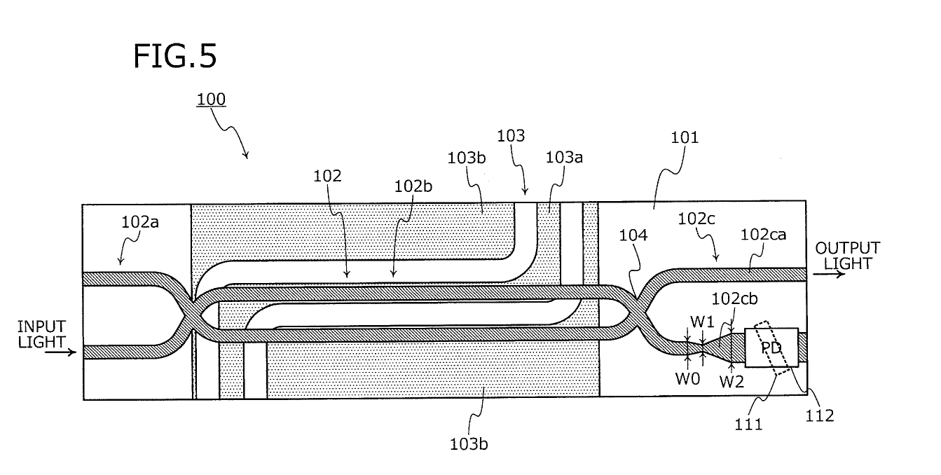

FIG. 5 is a plane view of the optical device according to a third embodiment. The third embodiment further represents a configuration example for suppressing the deterioration of the extinction ratio. In the first and the second embodiments, the groove 111 is formed at a right angle to the monitoring optical waveguide 102cb and a portion of the light is reflected to become reflected return light or a portion of the reflected light is combined with the output light (output fiber) on the emission waveguide 102ca side and can possibly deteriorate the extinction ratio of the output light. To prevent such situations, as depicted in FIG. 5, the groove 111 is formed and disposed obliquely to the monitoring optical waveguide 102cb, thereby enabling reduction of the light reflected to the incident side of the monitoring optical waveguide 102cb and reduction of the diffused light heading for the output fiber, and suppression of the deterioration of the extinction ratio of the output light.

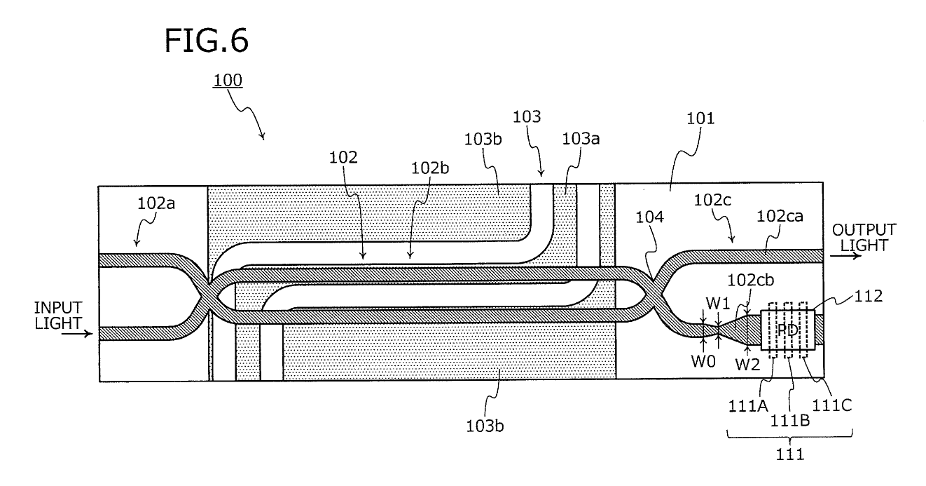

FIG. 6 is a plane view of the optical device according to a fourth embodiment. In the fourth embodiment, plural grooves 111 are formed at the PD 112. In the example of FIG. 6, the groove 111 is formed in three lines and the component of the light that passed through a first groove 111A can be reflected by each of a second groove 111B and a third groove 111C. Thus, with plural grooves 111 disposed, the received optical power of the PD 112 can be increased. While, in the example of FIG. 6, all of the plural grooves 111 are formed within a range of the dimensions of the PD 112, groove formation is not limited hereto and these grooves may be disposed beyond the dimension of the PD 112 along the monitoring optical waveguide 102cb.

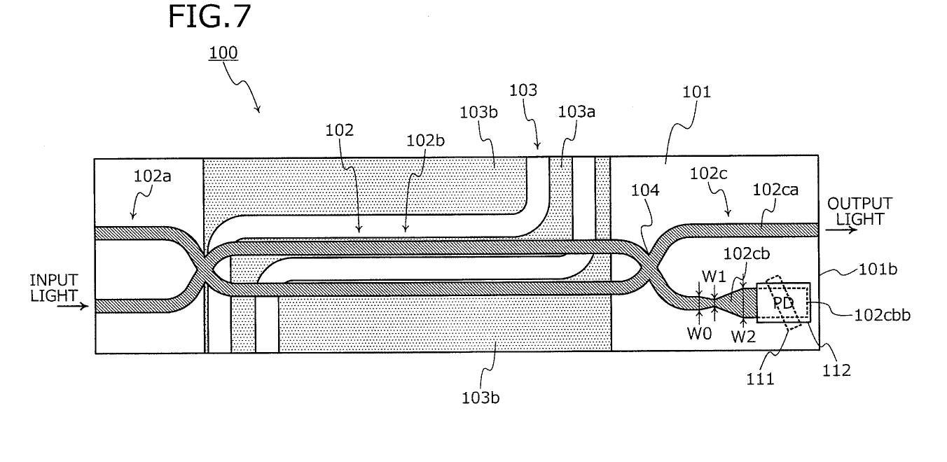

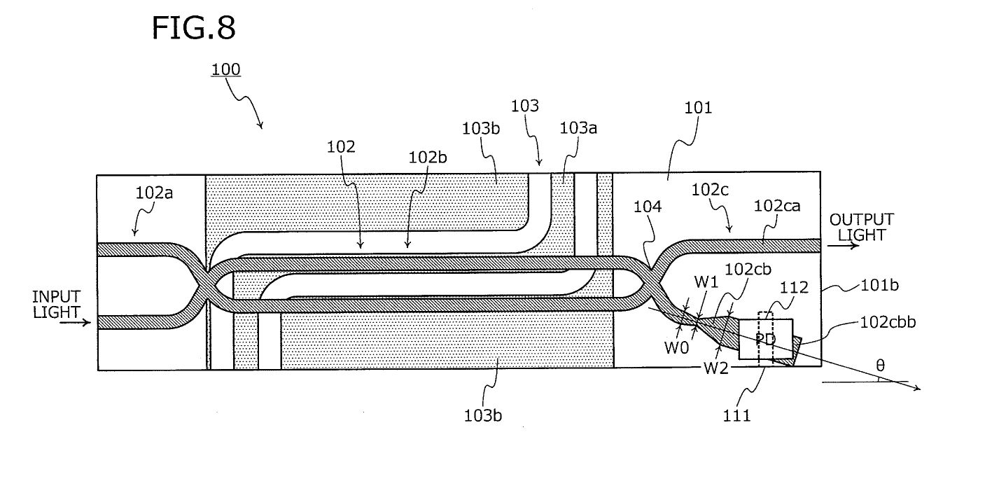

FIGS. 7 and 8 are plane views of the optical device according to a fifth embodiment. According to the first to the fourth embodiments, since the light is concentrated in a vicinity of the surface of the substrate 101, a component of the light that is not reflected by the groove 111 is likely to be re-combined with the waveguide. For this reason, as depicted in FIG. 7, the end of the monitoring optical waveguide 102cb terminates at a position short of the signal emission end surface of the substrate 101. In the example depicted in FIG. 7, the end 102cbb of the monitoring optical waveguide 102cb terminates at the position of the end of the PD 112 and does not extend to the position of the end surface (signal emission end surface) 101b of the substrate 101, thereby making it possible to cause the light re-combined by the reflection to escape in the direction of the substrate 101.

In addition to this configuration, as depicted in FIG. 8, the forming direction of the monitoring optical waveguide 102cb is slanted at a predetermined angle θ to the emission waveguide 102ca, in the direction away therefrom. Consequently, even if, out of the light traveling in the monitoring optical waveguide 102cb, there is unnecessary light that has passed through the groove 111 part, this unnecessary light can be caused to escape in the direction away from the output light of the emission waveguide 102ca.

In the configurations of FIG. 7 and FIG. 8 as well, the deterioration can be suppressed of the extinction ratio of the output light of the emission waveguide 102ca.

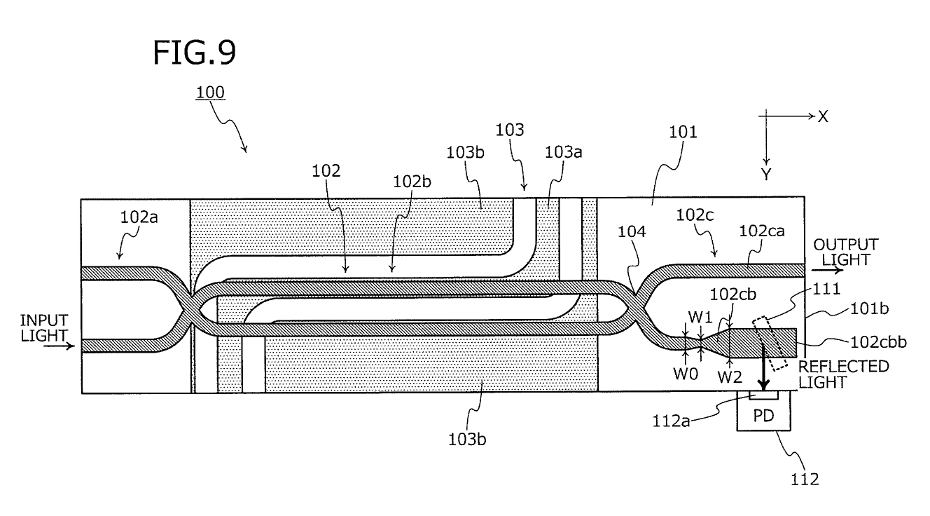

FIG. 9 is a plane view of the optical device according to a sixth embodiment. While the first to the fifth embodiments are configured to dispose the groove 111 for the monitoring optical waveguide 102cb to reflect the light toward the PD 112 over the groove 111, the light is reflected in a traverse direction in the sixth embodiment. The end 102cbb of the monitoring optical waveguide 102cb is located inside the substrate 101, at a position that does not reach the position of the end surface (signal emission end surface) 101b of the substrate 101.

In the example of FIG. 9, the groove 111 is disposed obliquely (e.g., at an angle of 45 degrees) to the traveling direction of the light in the monitoring optical waveguide 102cb and is caused to divert the travel of the light from the direction along the monitoring optical waveguide 102cb and reflect the light in a lateral (downward, in the drawing) direction of the substrate 101. The PD 112 is disposed on the side surface of the substrate 101 located in this reflection direction. The light receiving face 112a of the PD 112 is arranged to face in the direction of the side surface of the substrate 101 (groove 111). The PD 112 can be directly bonded to the substrate 101 by the adhesive or can be arranged close to the substrate 101 (having a space with the substrate 101). It is preferable for the groove 111 to have a total reflecting mirror surface. Although not depicted, the monitoring optical waveguide may be formed to extend in the direction of the light reflection by the groove 111, to the position of the PD 112. The PD 112 is not limited to disposal on the side surface of the substrate 101 but may be disposed on the top surface of the substrate 101 in the direction of the light reflection by the groove.

According to this configuration, since the PD 112 is disposed in the width (Y axis) direction of the substrate 101, the substrate 101 can be shortened in the length (X axis) direction and the total (package) size can be made smaller.

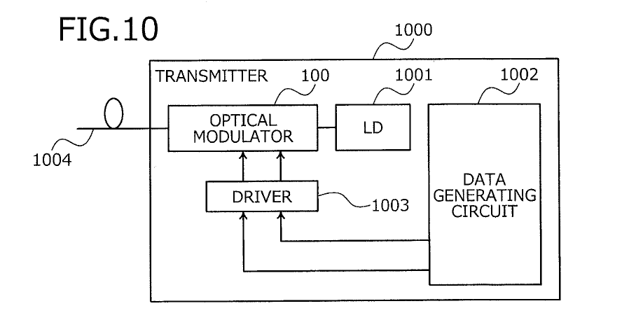

FIG. 10 is a block diagram of a transmitter having the optical device according to a seventh embodiment. This transmitter 1000 includes an optical modulator 100 as the optical device of each embodiment described above, a laser diode (LD) 1001 as a light source, a data generating circuit 1002, and a driver 1003. The emission light of a continuous wave (CW), etc., by the LD 1001 is input as the incident light of the optical modulator 100 and the output light from the emission waveguide 102ca is output to an external destination by way of an output fiber 1004. Data for transmission and generated by the data generating circuit 1002 is supplied as a drive signal by the driver 1003 to the electrodes 103 of the optical modulator 100. The optical modulator 100 modulates an optical signal by the drive signal and outputs to the output fiber 1004, the data for transmission.

With the smaller size of the optical modulator 100, the transmitter 1000 can be made smaller. Even the optical modulator 100 thus reduced in size can make the optical power received at the PD 112 of the optical modulator 100 large and enhance monitoring efficiency; and therefore, can perform a stable bias control. Consequently, the modulation efficiency of the transmitter 1000 can be enhanced.

In the above embodiments, description has been given using an optical modulator as the example of the optical device. In addition to an optical modulator, the optical device may be applied to an optical switch that has the same configuration and that performs a switching operation by a reversal of the voltage applied to the electrode 103.

According to the embodiments described above, with respect to one monitoring optical waveguide to detect the optical power among a pair of emission waveguides, the width of the PD portion of the optical waveguide is widened to make the effective refractive index difference large and to strengthen the light confinement in the depth direction of the substrate. Consequently, the optical power is concentrated in a vicinity of the substrate surface. Even if the groove disposed directly beneath the PD to reflect the light has a shallow depth, a sufficient amount of light can be caused to enter the PD and the light monitoring by the PD can be performed stably. Since the groove to be formed on the substrate need not be deep, the etching time can be shortened and the manufacturing throughput can be enhanced. The occurrence of cracking, etc. caused by the groove formation can be suppressed and the manufacturing yield can be enhanced.

Since the PD can be arranged on the substrate, stable light monitoring is enabled while making the overall size of the optical device smaller and enabling the monitoring efficiency of the optical device to be enhanced.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical device comprising:
an optical waveguide that includes an incident waveguide, parallel waveguides along an electrode, and emission waveguides, formed on a substrate having an electro-optical effect, a first emission waveguide among the emission waveguides is set as an output waveguide of signal light, for output to an external destination and a second emission waveguide among the emission waveguides is set as a monitoring optical waveguide for the signal light;
a photodetector that is disposed over the monitoring optical waveguide; and
a groove formed on a portion of the substrate, where the photodetector of the monitoring optical waveguide is disposed, wherein
the monitoring optical waveguide has a width that, as compared with the width at a starting point side, is formed to increase as the monitoring optical waveguide approaches the groove.

2. The optical device according to claim 1, wherein
the monitoring optical waveguide includes:
a first portion where, as compared with a width on the starting point side, the width of the optical waveguide is formed narrowly as the optical waveguide approaches the groove, permitting passage of only single mode; and
a second portion where, as compared with the width on the starting point side, the width of the optical waveguide is formed widely as the optical waveguide approaches the groove.

3. The optical device according to claim 1, wherein
the groove is formed obliquely to a traveling direction of light in the monitoring optical waveguide.

4. The optical device according to claim 1, wherein
the groove has a metal film of a high reflection rate disposed thereon.

5. The optical device according to claim 1, wherein
the groove has a slanted side surface and a raised reflection rate.

6. The optical device according to claim 1, wherein
the groove is disposed in plural in a vicinity of the photodetector of the monitoring optical waveguide.

7. The optical device according to claim 1, wherein
the photodetector is attached to the substrate by an adhesive and the groove is filled with the adhesive.

8. The optical device according to claim 1, wherein
the groove is set as an open space and the photodetector is attached to the substrate by bonding.

9. The optical device according to claim 1, wherein
the monitoring optical waveguide is formed to extend to a position at which an end does not reach an end surface of the substrate.

10. The optical device according to claim 1, wherein
the monitoring optical waveguide is formed slanted in a direction away from the output waveguide.

11. The optical device according to claim 1, wherein
the groove is disposed obliquely to the monitoring optical waveguide and has a reflection surface that diverts light away from a direction of the monitoring optical waveguide, and
the photodetector is disposed in a direction of the reflection of the light by the groove.

12. The optical device according to claim 11, wherein
the photodetector is disposed on a side surface of the substrate.

13. A transmitter comprising:
an optical waveguide that includes an incident waveguide, parallel waveguides along an electrode, and emission waveguides, formed on a substrate having an electro-optical effect, a first emission waveguide among the emission waveguides is set as an output waveguide of signal light, for output to an external destination and a second emission waveguide among the emission waveguides is set as a monitoring optical waveguide for the signal light;
a photodetector that is disposed over the monitoring optical waveguide;
a groove formed on a portion of the substrate, where the photodetector of the monitoring optical waveguide is disposed;
an optical modulator that is formed by the monitoring optical waveguide that has a width that, as compared with the width at a starting point side, is formed to increase as the monitoring optical waveguide approaches the groove;
a light source that emits light input to the optical modulator;
a data generating unit that generates a signal used for transmission; and
a driver that based on data generated by the data generating unit, drives the optical modulator via the electrode.
